(19) United States
(12) Patent Application Publication
(10) Pub. No.: US 2007/0289550 A1
(43) Pub. Date: Dec. 20, 2007

(54) Interactive cat toy

(76) Inventor: Wen-Tsan Huang, Yungho City (TW)

Correspondence Address: HERSHKOVITZ & ASSOCIATES, 2845 DUKE STREET, ALEXANDRIA, VA, 22314, US

(21) Appl. No.: 11/453,025

(22) Filed: Jun. 15, 2006

(51) Int. Cl. A01K 29/00

(52) U.S. Cl. 119/707

(57) ABSTRACT

An interactive cat toy has a base, a motor, a controlling circuit board electronically connected to the motor, a reduction assembly connected to a shaft of the motor, a rotating seat connected to the reduction assembly, a support plugged into the rotating seat and a fake bait fixed to the support. The motor, the controlling circuit board and the reduction assembly are mounted in the base. The rotating seat is mounted on the base and has multiple plug-on holes with different inclination angels. The motor driven to rotate by the controlling circuit board drive the rotating seat through the reduction assembly, so a rotating speed of the rotating seat is slower than that of the motor. Since the support can plug into one of the multiple plug-in holes, so a position of the fake bait is adjusted. Therefore, the cat toy provides a safe and varied playing ways.

### BACKGROUND OF THE INVENTION

1. Field of the Invention

The present invention relates to an interactive cat toy, and more particularly to an interactive cat toy that provides a rotating seat having multiple plug-in holes with different angels. One support with a fake bait can be plugged in one of the plug-in holes to adjust a position of the bait.

2. Description of Related Art

Animals have own natural instincts. For example, cats likes to chase after running small animals for fun or for hunting. However, when the cat becomes a pet, there are no alive animals provided to pet to chase. Therefore, a pet toy is invented.

With reference to FIG. 1 of the U.S. Pat. No. 5,925,387, a cat's toy has a base 11, a first supporting post 12, a coil spring 13, a second support 14, a rotatable connector 15 and a wire spring 16 with a bait 17. The first supporting post 12 is mounted on the base 11 and the coil spring 13 is connected between a free end of the first supporting post 12 and one end of the second support post 14. Therefore, a flexible spring joint 13 is provided between the first and second supporting posts 12, 14. The wire spring 16 with the bait 17 is connected to the second supporting post 14 through the rotatable connector 15.

When the cat sports with the bait 17, the bait 17 will move to many unfixed positions and seems an alive bait to attract the cat. Therefore, the cat chases after the alive bait when the cat continuously sports with it. However, most cats tired of this pet toy since the fake bait 17 does not jump automatically if they do not play with it.

With reference to FIGS. 1 and 4 of the U.S. Pat. No. 6,892,675, an electronic pet toy is invented. The electronic pet toy provides an automatic rotatable bait and the cat can chase the rotatable bait. The electronic pet toy has a base 11, a motor-supporting structure 12, an elongated member 38, a flexible line 17 with a bait 16. The motor-supporting structure 12 is mounted on the base 11 and connected to the elongated member 38. The flexible line 17 with the bait 16 is connected to the elongated member 38 so the bait 17 is rotating when the motor is active. However, the electronic pet toy provides a rotatable bait 16, but the motor is easily damaged. When the cat catches the bait 16, a shaft of the motor is forced to stop rotating since the elongated member 38 is directly connected to the shaft of the motor, so the motor is easily damaged since the elongated member 38 is directly connected to a shaft of the motor.

Further, another electronic pet toy is proposed by the U.S. Pat. No. 5,119,001 (Moore et al.) or U.S. Pat. No. 5,675,225. With reference to FIG. 2 of the Moore et al., the electronic pet toy has a base 10, a motor-belt drive mechanism 30, a vertical member 22, an L-shaped elbow 20, a horizontal member 18 and a line 16 with a bait 14. The motor-belt drive mechanism 30 is mounted in the base 11 and connected to the vertical member 22. Therefore, the vertical member 22 is driven to rotate by the motor-belt drive mechanism 30. The horizontal member 18 is connected to the free end of the vertical member 22 through the L-shaped elbow 20 and the line 16 with the bait 14 is tied on the horizontal member 18, so the bait 14 will move and used as an alive bait to attract the cat when the motor-belt mechanism 30 drives the vertical member 22 to rotate.

According to the abstract of the Moore et al., the motor-belt drive mechanism uses the gears to provide enough torque to insure self restarting after being stopped by a playful cat. However, when some small cats play with the electronic pet toy, they are easily dragged by line of the pet toy since the pet toy has large torque. Therefore, the motor-belt drive mechanism is used to increase enough torque not decrease the rotating speed. Further, the vertical member is connected to the horizontal member through the L-shaped elbow, so the L-shaped elbow is easily damaged when the cat catches, pulls and drags the bait. Besides, the electronic pet toy has a complex structure.

Therefore, the present invention provides a new electronic cat toy to overcome the forgoing mentioned drawbacks of conventional cat toys and provide varied playing ways.

### SUMMARY OF THE INVENTION

The main objective of the present invention is to provide an interactive cat toy that provides a rotating seat having multiple plug-in holes with different inclination angels and a safe rotating speed to prevent a cat from dragging by the electronic cat toy when the cat caught a bait.

The interactive cat toy has a base, a motor, a controlling circuit board electronically connected to the motor, a reduction assembly connected to a shaft of the motor, a rotating seat connected to the reduction assembly, a support plugged into the rotating seat and a fake bait fixed to the support. The motor, the controlling circuit board and the reduction assembly are mounted in the base. The rotating seat is mounted on the base and has multiple plug-on holes with different inclination angels. The motor driven to rotate by the controlling circuit board drive the rotating seat through the reduction assembly, so a rotating speed of the rotating seat is slower than that of the motor. Since the support can plug into one of the multiple plug-in holes, so a position of the fake bait is adjusted. Therefore, the cat toy provides a safe and varied playing ways.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an interactive cat toy in accordance with the present invention;

FIG. 2 is a perspective view in partial of an interactive cat toy in accordance with the present invention;

FIG. 3 is a top plan view in partial of the interactive cat toy in accordance with the present invention;

FIG. 4 is a bottom plan view of the interactive cat toy in accordance with the present invention;

FIG. 5 is a top plan view of a half-ball support with four plug-in holes of the interactive cat toy in accordance with the present;

FIG. 6 is a cross sectional view of the half-ball rotating seat taken along with 6-6 line in FIG. 5;

FIG. 7 is a cross sectional view of the half-ball rotating seat taken along with 7-7 line in FIG. 5;

FIG. 8 is a circuit diagram of a controlling circuit board of the interactive cat toy in accordance with the present invention; and

FIG. 9 is a schematic view of a rotating direction and order of the half-ball rotating seat in accordance with the present invention.

### DETAILED DESCRIPTION OF THE PREFERRED EMBODIMENT

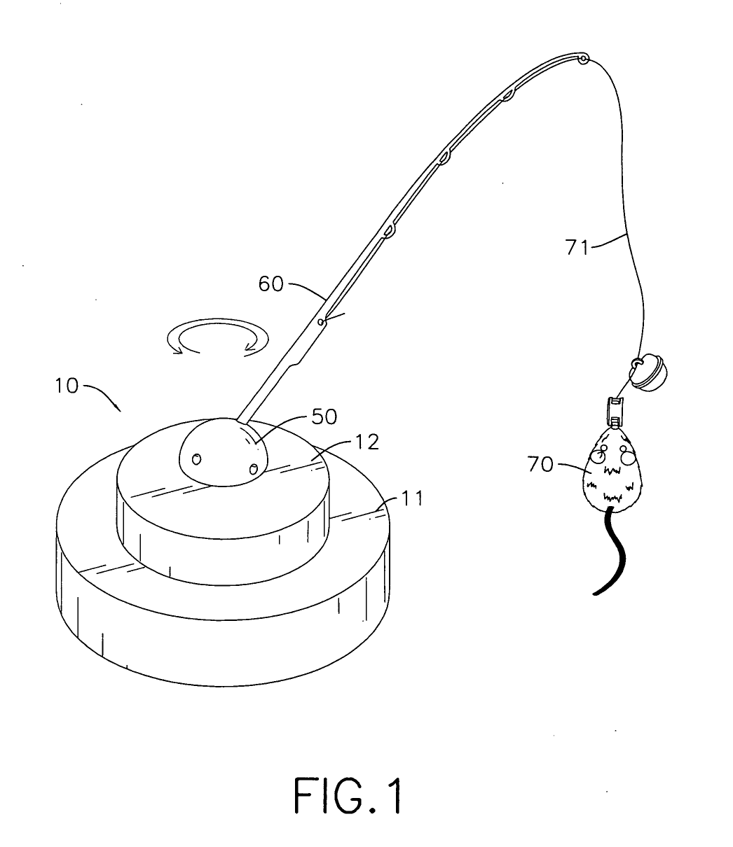

With reference to FIG. 1, a preferred embodiment of an interactive cat toy in accordance with the present has a base (10), a motor (20) having a shaft, a controlling circuit board (30) having a controlling circuit (30a), a reduction assembly (40), a rotating seat (50), a support (60) and a fake bait (70).

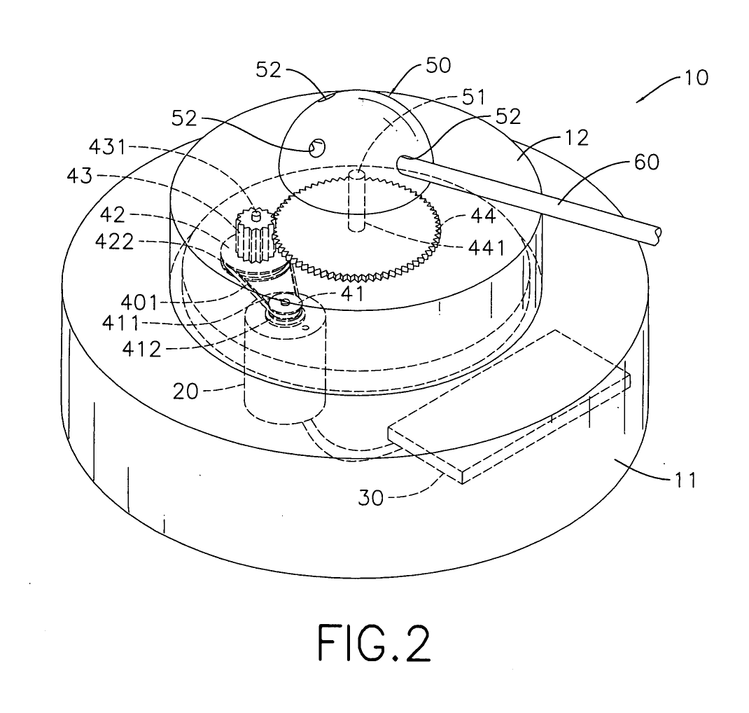

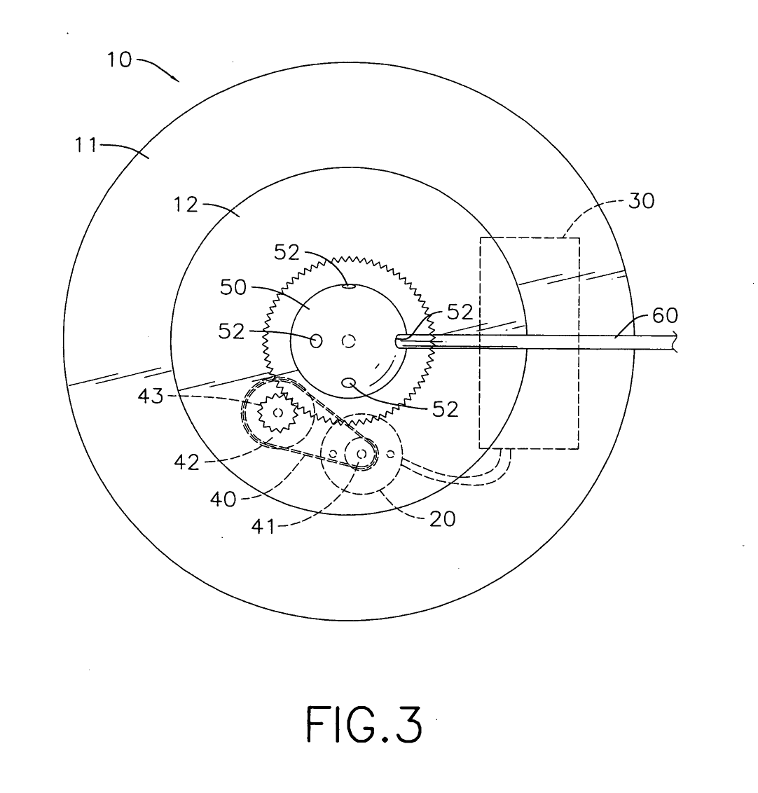

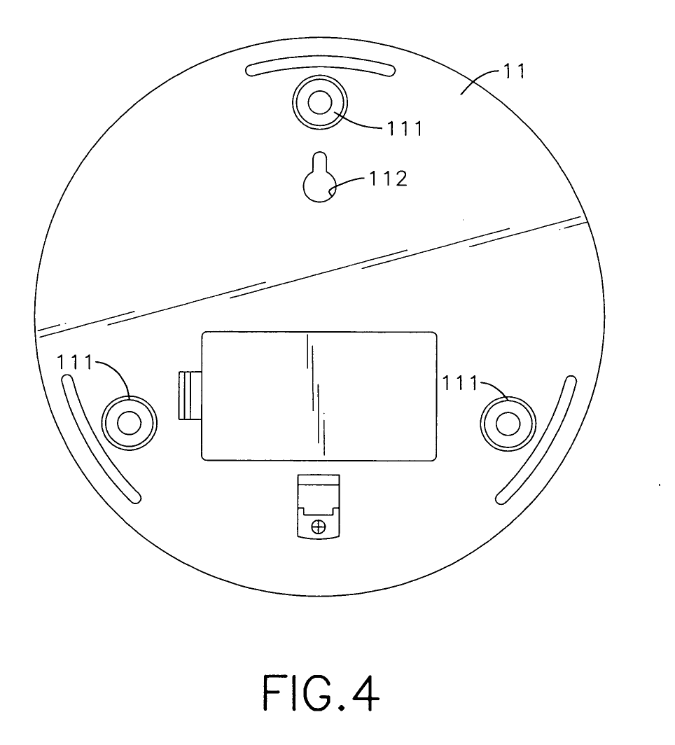

The base (10) can be consisted of a lower casing (11) and an upper casing (12) mounted on the lower casing (11). With further reference to FIG. 4, a bottom of the lower casing (11) has multiple skidproof pads (111) and a hook hole (112). Therefore, the cat toy can be easily stored on the wall. With reference to FIGS. 2 and 3, the motor (20) and the controlling circuit board (30) are mounted in the lower casing (11) and the reduction assembly (40) is mounted in the upper casing. The rotating seat (50) is mounted on the upper casing (12).

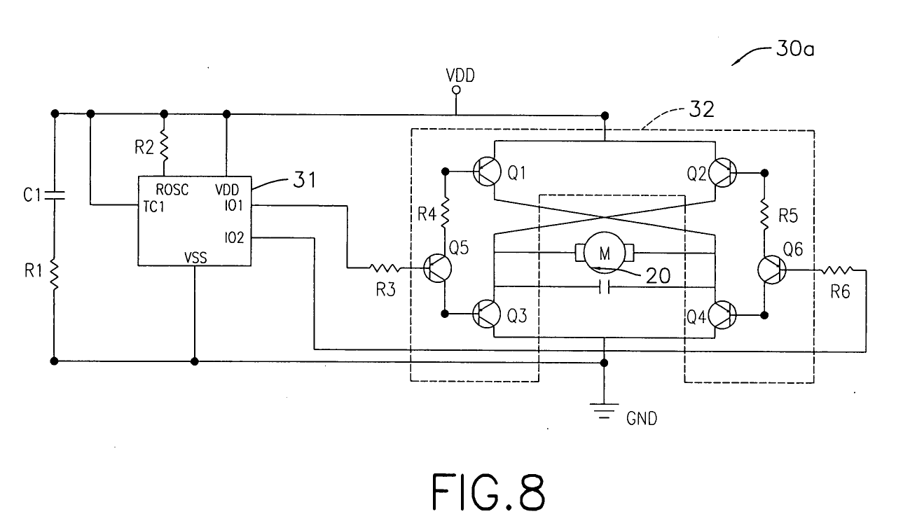

The shaft of the motor (20) protrudes to the upper casing (12) and is connected to the reduction assembly (40). The motor (20) is electronically connected to the controlling circuit board (30) and driven to rotate by the controlling circuit (30a) of the controlling circuit board (30), as shown in FIG. 8. The controlling circuit (30a) controls a rotating speed and direction of the motor (20).

The reduction assembly (40) has a belt device driven by the shaft of the motor (20), and a reduction gear device driven by the belt device.

The belt device has a small roller (41), a belt (401) and a larger roller (42). The small roller (41) has a first rim (412) and a first axle (411). The large roller (42) has a second rim (422) and a second axle. The first axle (411) is connected to the shaft of the motor (20) and the second axle is fixed on a suitable position of the upper casing (12). The belt (401) is mounted around the first and second rims (412, 422) of the small and large rollers (41, 42). The small roller (41) is driven to rotate by motor (20) and the belt (401) will further drive the large roller (42) to rotate.

The reduction gear device has a small gear (43) having a first center axle (431) and a large gear (44) having a second center axle (441). The first center axle (431) is connected to the second axle of the large roller (42), so the small gear (43) rotates synchronously with the large roller (42). The second center axle (441) is fixed a suitable position of the upper casing (120. The large gear (44) is engaged to the small gear (43), so the large gear (44) is driven by the small gear (43) and a rotating speed of the large gear (44) is slower than that of the small gear (43).

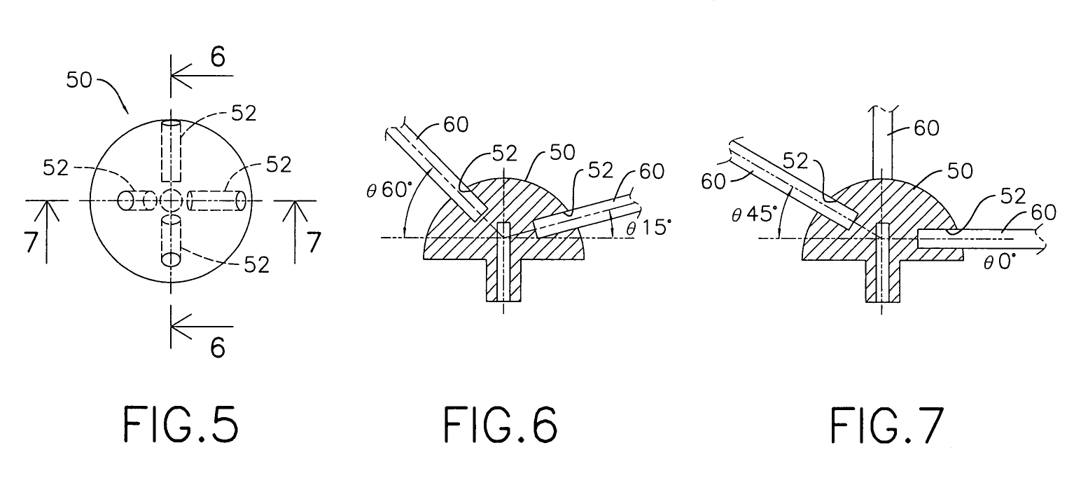

The rotating seat is (50) a form of a half-ball shaped. The rotating seat (50) has a center (51) and at least two plug-in holes (52). In this preferred embodiment, four plug-in holes (52) are defined on the half-ball rotating seat (50) according to different inclination angels. With further reference to FIGS. 6 and 7, four inclination angles (θ) of the plug-in holes (52) are 60, 15, 45, and 0 degrees.

The center (51) of the rotating seat (50) is connected to the second center axle (441) of the large gear (44) to be driven to rotate by the large gear (44). Therefore, the rotating speed of the half-ball rotating seat (50) is slower than that of the motor (20) to provide a reduction of rotating speed.

The support (60) can be made of a flexible material or hard material. With reference to FIG. 1, the support (60) is made of the flexible material and the fake bait (70) is fixed on the flexible support (60) through a line (71). The support (60) can plug into one of the four plug-in holes (52). Since the indication angles of the plug-in holes are different, the position of the fake bait (70) will be adjusted.

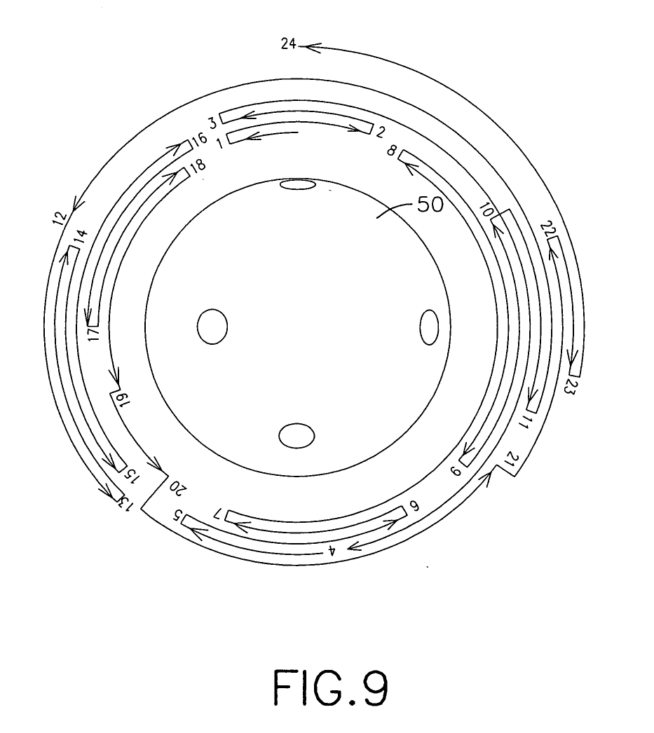

With reference to FIG. 8, a circuit diagram of the controlling circuit (30a) has a driver IC (31) having two output terminals (IO1, IO2) and a full bridge switching unit (32). The full bridge switching unit (32) is consisted of four transistors (Q1˜Q6) and connected to the motor (20). The two output terminals (IO1, IO2) of the driver IC (31) are connected to the full bridge switching unit (32) and alternatively output a controlling signal to the full bridge switching unit (32). Therefore, two different current loops of the motor (20) are alternatively established to drive the motor (20) to rotate. In addition, the driver IC (31) also builds a driving procedure therein. With reference to FIG. 9, the motor (20) drives the rotating seat (50) to rotate according to the driving procedure, so a non-fixed rotating route of the rotating seat (50) will be repeated. In FIG. 9, one preferred embodiment of the non-fixed rotating route presets 24 sub-routes. The directions and distances of the sub-routes are different.

Based on the forgoing description, the motor drives the rotating seat through the reduction assembly. When the bait is caught by the cat, the motor still continuously rotates and the rotating speed of the rotating seat is slower than that of the motor. The small cat is not dragged by the rotating seat. Further, the rotating seat provides multiple plug-in holes for the support, so the position of the bait connected to the support can be adjusted. In addition, the driver IC builds the driving procedure to drive the motor to rotate in sequence, so the present invention provides a varied playing ways to the cat.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An interactive cat toy, comprising:
a base;
a motor having a shaft mounted in the base;
a controlling circuit board having a controlling circuit electronically connected to the motor and driving the motor to rotate;
a reduction assembly connected to the shaft of the motor;
a rotating seat connected to the reduction assembly to make a rotating speed of the rotating seat be slower than that of the motor and having a center and multiple plug-in holes with different inclination angles;
a support plugged into one of the plug-in hole; and
a fake bait connected to the support.

2. The interactive cat toy as claimed in claim 1, the base comprising:
a lower casing having a bottom and in which the motor and the controlling circuit board are mounted; and
an upper casing mounted on the lower casing and which the reduction assembly and the rotating seat are mounted in and the rotating seat is mounted on; wherein the shaft protrudes to the upper casing and connected to the reduction assembly.

3. The interactive cat toy as claimed in claim 2, the bottom of the lower casing comprising multiple skidproof pads and a hook hole.

4. The interactive cat toy as claimed in claim 2, the reduction assembly comprising:
a belt device having
a small roller having a first rim and a first axle connected to the shaft of the motor;
a large roller having a second rim and a second axle fixed on a first position of the upper casing; and
a belt mounted around the first and second rims of the small and large rollers; and
a reduction gear device having:
a small gear having a first center axle connected to the second axle of the large roller; and
a large gear engaged with the small gear and having a second center axle fixed another position of the upper casing.

5. The interactive cat toy as claimed in claim 4, the rotating seat being a form of a half-ball shaped and having a center connected to the second center axle of the large gear to be driven to rotate by the large gear.

6. The interactive cat toy as claimed in claim 5, wherein there are four plug-in holes and the inclination angles of the four plug-in holes are 0, 15, 30 and 45 degrees.

7. The interactive cat toy as claimed in claim 1, the support being made of a flexible material or hard material.

8. The interactive cat toy as claimed in claim 7, the fake bait is fixed to the support through a line.

9. The interactive cat toy as claimed in claim 1, the controlling circuit comprising:
a driver IC building a driving procedure therein and having two output terminals; and
a full bridge switching unit electronically connected between the two output terminals and the motor to drive the motor to rotate.

10. The interactive cat toy as claimed in claim 9, the full bridge switching unit consisted of four transistors.
